(19) United States
(12) Patent Application Publication
(10) Pub. No.: US 2005/0264889 A1
(43) Pub. Date: Dec. 1, 2005

(54) Display member and panel display unit

(75) Inventors: Yoshihiko Gotoh, Yokkaichi-city (JP); Hironobu Yamamoto, Yokkaichi-city (JP)

Correspondence Address: GREENBLUM & BERNSTEIN, P.L.C., 1950 ROLAND CLARKE PLACE, RESTON, VA, 20191, US

(73) Assignee: Sumitomo Wiring Systems, Ltd., Yokkaichi-city (JP)

(21) Appl. No.: 11/137,553

(22) Filed: May 26, 2005

(30) Foreign Application Priority Data
May 27, 2004 (JP) 2004-157987

(51) Int. Cl. G02F 1/1335; G02B 5/02; G02B 13/20

(52) U.S. Cl. 359/599; 359/707

(57) ABSTRACT

A display member that provides clear and uniform illumination through a light diffusion layer while enabling a wider selection of display colors that can be applied to the part of the display member body not covered by a light-blocking layer in order to clearly identify the uncovered part when the display member is not illuminated. A display member body is covered by a light-blocking layer. Light irradiating the rear side of the display member body illuminates the front side of the display member body through a displaying part that includes a region where the light-blocking layer has not been applied. The display member body provides a light diffusing effect through a light diffusing layer, and includes a specifically colored transparent layer which is applied over the light diffusing layer and which has greater transparency than the light diffusing layer.

### BACKGROUND OF THE INVENTION

1. Field of the Invention

The present invention relates to an illuminated display member attached to a panel, for example, in an automobile passenger compartment, and a panel display unit to which the display member is attached.

2. Description of Related Art

Illumination functions have been incorporated into automotive instrument and display panels to which various devices, such as audio units and the like, are installed. The purpose of the illumination function is to render words and markings on a display member clearly visible at night.

Japanese Utility Model Patent No. 6-38127 describes a display member that incorporates an illumination function. This display member (described in Japanese Utility Model Patent No. 6-38127 as illumination key (5) is constructed from a transparent resin, or like substance, and is covered with a light-blocking paint layer within which are specifically shaped areas where the paint covering has not been applied.

When the rear side of this type of display member is illuminated with light, the light is only able to pass through a portion of the display member where there is an absence of paint. Thus, the light becomes visible on the front side of the display member to make the non-painted area clearly visible at night.

When the display member described in Japanese Utility Model Patent No. 6-38127 is of a uniformly transparent color, there is a significant difference in the intensity of the light passing through portions of the display member closer to the light source, as compared to the light passing through portions farther away from the light source. Moreover, there is the problem of those portions of the display member outside of the light irradiation region seeming to appear transparent, producing a shadow, at certain viewing angles.

Therefore, it would be preferable to construct the display member from a material able to diffuse light, in order to suppress variations in light intensity, resulting from changes in viewing angle of the non-painted portion, that is, with respect to the visible displaying part of the display member. For example, acrylic resin, ABS resin, other like material, which are of a translucent white color, are preferable.

Because the non-painted portions on the front of the display member are exposed, they appear as the color of the display member itself during daylight hours, when the display member is not illuminated. It is preferable that the color of the non-painted portions, that is, the portions which are to be illuminated, be clearly differentiated from the color of the paint coating. For example, when the paint coating is a relatively pale color, the color of the display member itself should be dark. Also, for design reasons, there are cases where it is required that a special color be used for the non-painted portion.

Incidentally, there are restrictions with regard to the type of material that can be used to provide this type of display member body with a light diffusion function. In this respect, there are significant restrictions as to the color of the display member body, i.e., the color of the non-painted portions of the display member when not illuminated. For example, when the display member body is made from acrylic resin, ABS resin, or other like material having a translucent white color as noted previously, the color of the display member is inherently limited to a whitish color.

In other words, when it is desired that a conventional display member having a light diffusion function be uniformly illuminated, there is a problem in the choice of colors that can be used for the displaying part, i.e., the non-painted portion is significantly restricted if the displaying part is to be clearly visible in a non-illuminated condition.

### SUMMARY OF THE INVENTION

One feature of the present invention is to provide a transparent display member body and a light-blocking layer applied to the front surface thereon, in which a displaying part is formed by the absence of the light-blocking layer on a specified portion of the display member body. By irradiating the rear part of the display member body with light and passing the light through the portion not covered by the light-blocking layer, the front of the display member body may be illuminated. The display member body also incorporates a light diffusion layer which has a light diffusion effect, a transparent layer which is applied over the front side of the light diffusion layer, has the degree of color transparency of the transparent layer being greater than that of the light diffusion layer, and is of a specific color. Further, the light diffusion layer is located at least behind the displaying part to cover the part.

The display member is structured whereby light applied to the rear side of the display member body passes through a light diffusion layer and transparent layer which have been applied to the display member body. The light illuminating the front surface of the display member body passes only through the portion of the display member body to which the light blocking layer has not been applied, thereby resulting in the clear and uniform illumination of the shape of the displaying part, without fluctuations in the light intensity, due to the light diffusion effect provided by the light diffusion layer.

Moreover, despite restrictions relating to the color of the light diffusion layer (the light diffusion layer being of a translucent white color, for example), the color of the display member body when not illuminated, i.e., the color of the portion not covered by the light-blocking layer, can be established to a desired color, or a color similar to the desired color, by the color of the transparent layer applied over the front surface of the diffusion layer.

Specifically, the transparent layer of the display member body may be formed as a transparent color film applied over the front of the light diffusion layer. The light diffusion layer and transparent layer may be respectively formed from a light diffusing resin and transparent resin as a single integrated structure (for example, two color molding, coinjection molding, etc.) in order to simplify the display member structure and lower costs through reduced manufacturing procedures.

The display member may also include a panel, in which a rear side of the display member is illuminated by a light source behind the panel.

The panel display unit may include the display member in the form of a control part attached to the panel as a portion of the display member (or in the display member), in which the control part is depressably operated from the front of the panel.

Another feature of the present invention is to provide a display member that includes a transparent display body, a light-blocking layer provided on a front surface of the display body, a displaying portion comprising at least one area on the front surface of the display body that lacks the light-blocking layer, a light diffusion layer provided opposite the displaying portion configured to diffuse light, and a transparent layer of a particular color provided on a second surface of the display body and being more transparent than the light diffusion layer. The displaying portion is illuminated when light illuminates a rear surface of the display member.

The light diffusion layer may be translucent white. The transparent layer may be adhered to the light diffusion layer or the transparent layer and the light diffusion layer may be a single one-piece structure. The light diffusion layer may be formed of a light diffusing resin and the transparent layer may be formed of a transparent resin.

Additionally, the rear of the display member is illuminated by a light source behind the panel. The display member includes a control part attached to the panel that is actuated by a depressing operation.

Due to the presence of the light diffusion layer, the present invention is able to provide uniform display illumination without variations in light intensity. Moreover, in regard to the color of the displaying part when not illuminated, i.e., the part not covered by the light-blocking layer, the use of a transparent color layer applied over the surface of the light diffusion layer widens the selection of the aforesaid color.

### BRIEF DESCRIPTION OF THE DRAWINGS

The above, and other objects, features and advantages of the present invention will be made apparent from the following description of the preferred embodiments, given as nonlimiting examples, with reference to the accompanying drawings in which:

FIG. 1 is an exploded perspective view of a panel display unit according an embodiment of the present invention;

FIG. 2A is a front elevation view illustrating the audio control buttons and the holder of the present invention;

FIG. 2B is a cross-section view taken along the lines A-A of FIG. 2A;

FIG. 3A is a detailed cross-sectional view taken along the lines B-B of FIG. 2A;

FIG. 3B is an enlarged cross-sectional view of circled area C in FIG. 3A; and

FIG. 4 shows a cross-sectional illustration of a modified structure of the control button.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

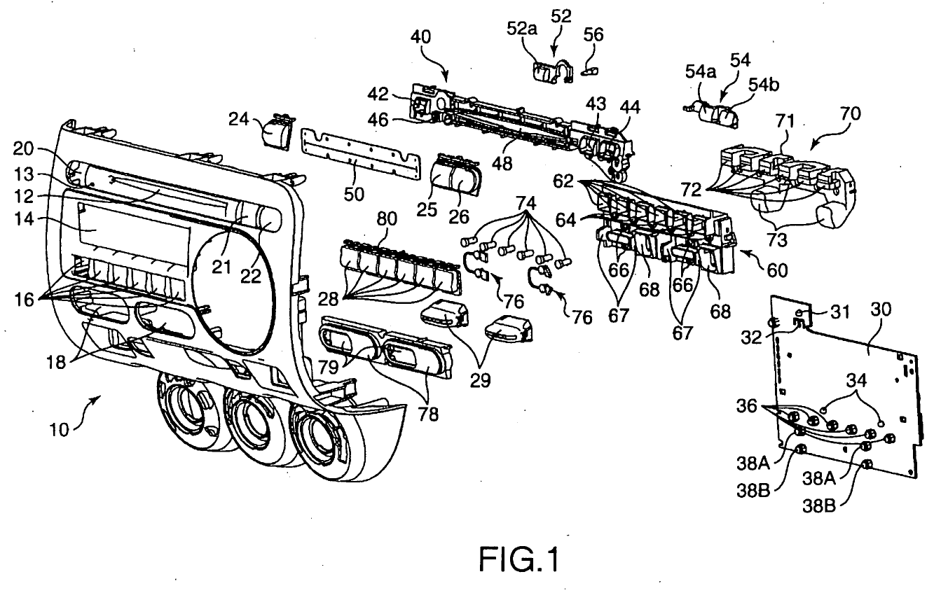

The following will describe the preferred embodiments of the invention with reference to the drawings. FIG. 1 depicts the panel display unit of the present invention embodied in the form of an automotive instrument panel 10. The instrument panel 10 includes, starting from the top portion down, a CD access orifice 12, an LCD display orifice 14, six audio control orifices 16, and a pair of horizontally disposed rocker switch orifices 18. A light display orifice 13 is located in proximity to the CD access orifice 12, one CD control button orifice 20 is located to the left of the CD access orifice 12, and a pair of CD control button orifices 21 and 22 are located to the right of the CD access orifice 12. All of the orifices noted above are formed as voids, completely penetrating the front wall portion of the instrument panel 10.

The CD control buttons 24, 25, and 26, and an audio control button 28 extend from the rear of the panel to the front, through the CD control button orifices 20, 21, and 22 and the audio control button orifice 16, and are thus operable through these orifices. Moreover, a rocker switch cover 78 installs to the rocker switch orifice 18 from the rear of the panel, and rocker switch lever 29 installs to a lever orifice 79 from behind, the lever orifice 79 being integrally formed to the rocker switch cover 78, thereby allowing the rocker switch lever 29 to pivot forward and backward.

The CD control buttons 24, 25, 26, the audio control button 28, and the rocker switch cover 78, are constructed of a transparent material. Of these, the structure and materials of the six audio control buttons 28, which will be subsequently described, correspond to the display member (and operating member) of the present invention.

A printed circuit board 30 is located behind the instrument panel 10. The printed circuit board 30 includes, from the top down, a lamp 31, a light emitting diode 32, right and left lamps 34, six switch elements 36, and two pairs of switch elements 38A and 38B, each pair being vertically disposed at respective left and right locations.

The lamp 31 serves as the light source for the CD control button 24, and is positioned accordingly. The light emitting diode 32 is positioned to project light through the light display orifice 13 toward the front side of the panel, and the two lamps 34 serve as light sources positioned to illuminate all of the audio control buttons 28 and the rocker switch cover 78 from the rear. The switch elements 36 are positioned so as to allow their push-in operation through audio control buttons 28, and the switch elements 38A and 38B are positioned so as to allow their push-in operation through the see-saw like pivoting movement of the rocker switch levers 29. Moreover, although not shown in the drawings, lamps are installed at positions separate from the printed circuit board 30 to illuminate the CD control buttons 25 and 26.

Although not shown in the drawings, the printed circuit board 30 also includes an LCD (liquid crystal display) which inserts into LCD display orifice 14 from behind.

A light guide holder 40 is placed between the printed circuit board 30 and CD control button 24. The light guide holder 40 is equipped with the light guide support parts 42, 43, and 44 which are located directly behind the CD control buttons 24, 25, and 26, a light guide support part 46 which is located directly behind light orifice 13, and a CD access window 48 which is located directly behind the CD access orifice 12. The light guide support parts 42, 43, 44, and 46, and a CD access window 48, are formed as voids which penetrate the light guide holder 40. Moreover, a CD felt material 50 is installed around the perimeter of the CD access window 48 so as to come into contact with a CD (compact disc) when the CD passes through the CD access window 48.

A light guide 52 is supported by the light guide support part 42, a light guide 54 is supported by the light guide support parts 43 and 44, and the light guide 56 is supported by the light guide support part 46.

The light guide 52 directs the light emitted by the lamp 31 toward the rear part of the CD control button 24, is entirely made from a relatively transparent material which may be acrylic resin or the like, and includes a lens 52a which is a more thickly formed part that extends forward (toward the panel) at a predetermined position. The lens 52a is inserted into the light guide support part 42 from the rear, and is thus supported by the light guide holder 40.

In the same manner, the light guide 54 directs light emitted from a lamp (not shown in the drawings) to the rear side of the CD control buttons 25 and 26, is made from a relatively transparent material which may be acrylic resin or the like, and includes the lenses 54a and 54b which are more thickly formed parts that extend forward (toward the panel). The lenses 54a and 54b are inserted into the light guide support parts 43 and 44, respectively from the rear, and are thus supported from the rear by the light guide holder 40.

Additionally, the light guide 56 directs light emitted from the light emitting diode 32 to the external area through the light display orifice 13, is made entirely from a relatively transparent material which may be acrylic resin or the like, and is inserted into the light guide support part 46 from the rear, and is thus supported by the light guide holder 40.

A holder unit 60 is installed between the printed circuit board 30 and the audio control buttons 28, and between the printed circuit board 30 and the rocker switch levers 29.

The holder unit 60 includes a light guide support part 62, actuator support parts 64 and 66, and a light guide support part 68.

The light guide support part 62 is installed directly behind each audio control button 28, and the light guide support part 68 is installed directly behind the rocker switch cover 78. An actuator support part 64 is installed directly beneath each light guide support part 62 opposing the switch elements 36 on the printed circuit board 30, and actuator support parts 66 are installed in respective opposition to the switch elements 38A and 38B directly behind each rocker switch lever 29.

A lever support wall 67, which protrudes from the front of the holder unit 60, supports the rocker switch lever 29 so as to allow its pivoting movement forward and backward.

A light guide 70 is supported by each light guide support part 62, and each actuator 74 is supported by a corresponding actuator support part 64.

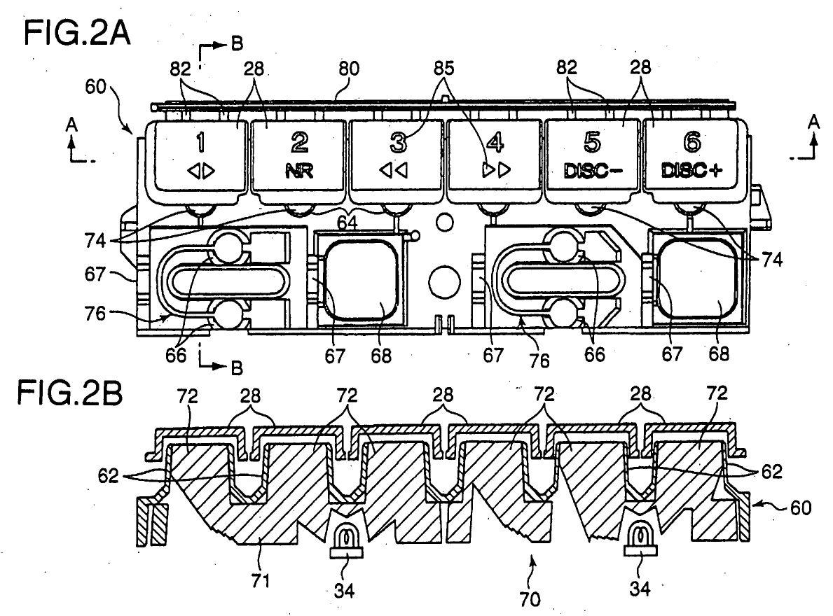

The light guide 70, which directs light emitted from the lamps 34 to the rear side of each audio control button 28 and rocker switch cover 78, is made of a comparatively transparent acrylic resin or other like material. To be more specific, the light guide 70, as shown in FIG. 2B, includes a main part 71 which extends horizontally to the left and right, thickly formed lenses 72 which extend upward from the front portion of the main part 71, and lenses 73 (as shown in FIG. 1) that extend downward and then forward from the main part 71. The main part 71 and the lenses 72 and 73 are integral to the light guide 70. The lenses 72 and 73 are respectively inserted into the light guide support parts 62 and 68 from behind, thus creating a structure whereby the light guide 70 is completely supported by the light guide holder 40.

Operating pressure applied to an audio control button 28 is transferred to a corresponding switch element 36 (located behind the lower edge of the audio control button 28) via actuator 74, each actuator 74 being formed as a pin-shaped member movably supported in the axial direction by the actuator support part 64 of the holder unit 60. In a similar manner, the pivoting movement of the rocker switch lever 29 in the forward and backward directions, effected by operating pressure applied thereto, is conveyed to the switch element (38A or 38B) via actuator 76, each actuator 76 being movably supported in the fore-aft direction by the actuator support part 66.

In this type of panel display unit, the CD control button 24 is illuminated by the mechanism through which the lens 52a of the light guide 52 conveys light from the illuminated lamp 31 of the printed circuit board 30 to the CD control button 24. In a similar manner, the CD control buttons 25 and 26 are illuminated by the mechanism through which the lenses 54a and 54b of the light guide 54 convey light from an illuminated lamp (not shown in the drawings) to the CD control buttons 25 and 26. Additionally, the light guide 56 conveys light emitted from the light emitting diode 32 to the front of the panel at the light display orifice 13. Furthermore, the audio control buttons 28 are illuminated by light emitted from the lamps 34 being conveyed to each audio control button 28 through each lens 72 of the light guide 70, and the rocker switch covers 78 are illuminated by the light emitted from the lamps 34 being conveyed to each rocker switch cover 78 through each lens 73 of the light guide 70.

Pressure applied to the audio control button 28 is conveyed to the switch element 36 through the actuator 74, thus switching the switch element 36 to an ON state. Also, the pivoting movement of the rocker switch lever 29 is conveyed to a corresponding switch element (38A or 38B) through the actuator 76 when the rocker switch lever 29 is pivotally operated in either the forward or backward direction, thus switching that switch element to an ON state.

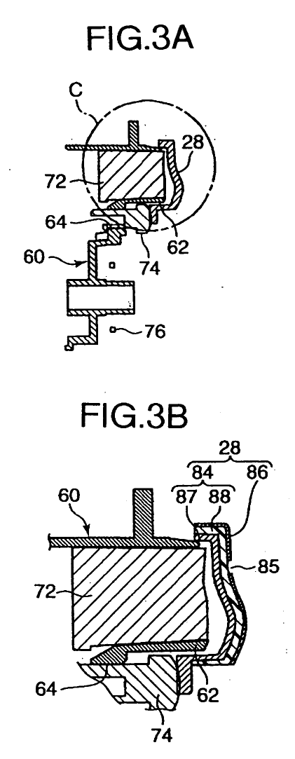

The following will provide a detailed description, with reference to FIGS. 2A, 2B, 3A and 3B, of the present invention, as embodied in the structure of the audio control buttons 28.

The audio control buttons 28, a support member 80, and thin hinge parts 82 are formed as a single integrated structure of synthetic resin in which the control buttons 28 are connected, in horizontal alignment, to the common support member 80 through the thin hinge parts 82. With the support member 80 fixedly installed to the rear of the instrument panel 10, each audio control button 28 may be individually pressed and thereby moved through the distortional flexing of the hinge part 82.

As shown in FIG. 3B, each audio control button 28 is structured as a button body 84 (a body of the display) on which a covering of a light-blocking paint (an opaque layer) 86 has been applied.

The button body 84 is structured to include a light diffusion layer 87 over which a transparent layer 88 is applied to the front-facing surface thereon. The light diffusion layer 87 provides a light diffusion effect that diffuses the light from the lens 72 of the light guide 70 over the complete button. The diffusion layer 87 may be formed from a transparent resin, such as an acrylic or polycarbonate resin, into which diffusion particles have been mixed to obtain a translucent white color, or from a material which is a naturally translucent white color, such as ABS resin. The transparent layer 88, which has greater transparency than the light diffusion layer 87, may be formed from a transparent resin, such as the aforesaid acrylic resin or polycarbonate resin, into which coloring particles (of a black color, for example) are mixed to obtain the desired color density.

The light diffusion and transparent layers 87 and 88 may be formed as a single structure by two color molding, or may be formed as a structure in which a transparent colored film is adhered to the top of the diffusion layer 87.

A paint layer 86 is formed of an opaque light-blocking paint applied over the transparent layer 88 wherein missing portions of the paint layer 86 have contours formed in the shapes of numbers, letters, and various markings. In other words, a non-painted portion 85 (e.g., the above-noted missing portions) becomes the displaying part by exposing the surface of the transparent layer 88.

Specifically, the thickness of the paint layer 86, diffusion layer 87, and transparent layer 88 may be established as appropriately required, but generally speaking, a thickness of 30 μm for the paint layer 86 and 0.7˜1.2 mm for the diffusion layer 87 and transparent layer 88 is appropriate.

Moreover, the light-blocking layer need not be of paint as specified in this embodiment, but may, for example, be a highly opaque material, such as a film or other like material, in which specific portions have been cut out and attached to the surface of the button body 84.

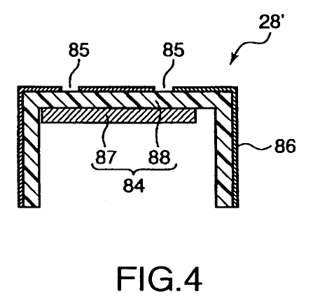

Furthermore, the light diffusion layer 87 need not be applied over the entire surface of the button body 84, but may be provided only in the region behind the non-painted portion 85 so that the light diffusion effect illuminates only the portion to which no paint has been applied. As shown by the structure of the control button 28′ in FIG. 4, for example, the diffusion layer 87 may be provided at only one portion of the button body 84.

Because the above-described structure conveys the light in the lenses 72 to the audio control buttons 28 through the light diffusion layer 87 and transparent layer 88 formed on each button body 84, therefore allowing light to pass only through the non-painted portion 85 where the paint layer 86 has not been applied, the light diffusion effect provided by the light diffusion layer 87 allows the distinct and uniform illumination of the shape of the non-painted portion 85 with minimal fluctuation in light density. Moreover, even though the composition of the light diffusion layer 87 may be limited to that which provides a translucent white appearance, the color of the non-illuminated button body 84, that is, the color of the non-painted portion 85, may be established as a desired color, or a color close to a desired color, by adding color to the transparent layer 88 applied over the diffusion layer 87. Therefore, even though the paint layer 86 may be of a comparatively pale color, establishing the non-painted portion 85 as a comparatively dark color will result in clearly defined display of the non-painted portion 85 under both illuminated and non-illuminated conditions.

While the display member invention has been described in reference to the audio control buttons 28 shown in FIGS. 1, 2A, 2B, 3A, and 3B other control components, such as the CD control buttons 24, 25, and 26, and the rocker switch lever 29, may be structured according to the precepts of the present invention. Furthermore, the components to which the present invention may be applied are not limited to the control buttons described in this specification, but may also include, for example, the rocker switch cover 78 illustrated in FIG. 1.

Furthermore, the present invention is not limited to a panel display unit embodied as the automotive instrument panel 10 shown in FIG. 1, but may also be incorporated into display panels installed in various types of electronic devices, such as audio products, or buildings and the like.

The present disclosure relates to subject matter contained in priority Japanese Application No. 2004-157897, filed on May 27, 2004, which is herein expressly incorporated by reference in its entirety.

Although the invention has been described with reference to an exemplary embodiment, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed. Rather, the invention extends to all functionally equivalent structures, methods, and uses such as are within the scope of the appended claims.

1. A display member comprising:
a transparent display member body,
a light-blocking layer applied to a front surface of the display member body, and
a displaying part formed by an absence of the light-blocking layer on a specified portion of the display member body, the displaying part being illuminated on the front surface of the display member when light irradiates a rear part of the display member body,
wherein the display member body includes a light diffusion layer that diffuses light and a transparent layer of a specific color which is applied over a front side of the light diffusion layer, the transparent layer having a greater degree of color transparency than that of the light diffusion layer, and the light diffusion layer being located behind at least the displaying part.

2. The display member according to claim 1, wherein the light diffusion layer is translucent white.

3. The display member according to claim 1, wherein the light diffusion layer and the transparent layer of the display member body are a one-piece structure, the light diffusion layer comprising a light diffusing resin, and the transparent layer comprising a transparent resin.

4. The display member according to claim 1, further comprising a panel, wherein a rear side of the display member is illuminated by a light source behind the panel.

5. A panel display unit according to claim 4, wherein the display member is formed as a control part attached to the panel, the control part being operated by being pressed inwardly from the front side of the panel.

6. The display member according to claim 2, wherein the light diffusion layer and the transparent layer of the display member body are a one-piece structure, the light diffusion layer comprising a light diffusing resin, and the transparent layer comprising a transparent resin.

7. The display member according to claim 2, further comprising a panel, wherein a rear side of the display member is illuminated by a light source behind the panel.

8. The display member according to claim 3, further comprising a panel, wherein a rear side of the display member is illuminated by a light source behind the panel.

9. A display member comprising:
a transparent display body;
a light-blocking layer provided on a front surface of the display body;
a displaying portion comprising at least one area on the front surface of the display body that lacks the light-blocking layer;
a light diffusion layer provided opposite the displaying portion configured to diffuse light; and
a transparent layer of a particular color provided on a second surface of the display body and being more transparent than the light diffusion layer,
wherein the displaying portion is illuminated when light illuminates a rear surface of the display member.

10. The display member according to claim 9, wherein the light diffusion layer is translucent white.

11. The display member according to claim 9, wherein the transparent layer is adhered to the light diffusion layer.

12. The display member according to claim 9, wherein the transparent layer and the light diffusion layer comprise a one-piece structure.

13. The display member according to claim 9, wherein the light diffusion layer comprises a light diffusing resin and the transparent layer comprises a transparent resin.

14. The display member according to claim 10, wherein the light diffusion layer comprises a light diffusing resin and the transparent layer comprises a transparent resin.

15. The display member according to claim 10, further comprising a panel, wherein the rear of the display member is illuminated by a light source behind the panel.

16. The display member according to claim 13, further comprising a panel, wherein the rear of the display member is illuminated by a light source behind the panel.

17. The display member according to claim 15, wherein the display member comprises a control part attached to the panel, the control part being actuated by a depressing operation.

18. The display member according to claim 16, wherein the display member comprises a control part attached to the panel, the control part being actuated by a depressing operation.
